(19) United States
(12) Patent Application Publication
(10) Pub. No.: US 2023/0078331 A1
(43) Pub. Date: Mar. 16, 2023

(54) DYNAMICALLY CROSSLINKABLE POLYMERIC COMPOSITIONS, ARTICLES, AND METHODS THEREOF

(71) Applicant: Braskem S.A., Camaçari (BR)

(72) Inventors: Murilo Lauer Sanson, São Paulo City (BR); Kimberly Miller McLoughlin, Philadelphia, PA (US); Hadi Mohammadi, Philadelphia, PA (US); Nei Sebastião Domingues Junior, São Paulo City (BR); Ana Paula de Azeredo, São Paulo City (BR); Michelle Kay Sing, Philadelphia, PA (US)

(73) Assignee: Braskem S.A., Camaçari (BR)

(21) Appl. No.: 17/901,691

(22) Filed: Sep. 1, 2022

Related U.S. Application Data
(60) Provisional application No. 63/239,810, filed on Sep. 1, 2021.

(51) Int. Cl. C08K 5/098; C08K 5/01

(52) U.S. Cl. CPC C08K 5/098; C08K 5/01

(57) ABSTRACT

A polymeric composition may include a thermoplastic polymer including: at least one monomer selected from the group consisting of vinyl esters, C₂-C₁₂ olefins, and combinations thereof; and a dynamic crosslinking group; and a crosslinking agent to dynamically crosslink the thermoplastic polymer by ionic bonds or metal-ligand interaction.

### BACKGROUND

Ethylene vinyl acetate (EVA) is widely used to produce foams with light weight and very high toughness, resilience, and compression set. EVA foams find application in demanding applications such as running shoe midsoles as well as automotive and construction applications such as interior padding, carpet underlay, gaskets, etc. The polymer architecture that is required for EVA foams and other compact elastomeric applications that require high thermal resistance is a three-dimensional network, produced by crosslinking neighboring polymer molecules.

Covalently bonded polymer networks provide a balance of performance, properties, and durability. However, the same characteristics that make permanent networks excellent candidates in materials selection for high performance foams represent a difficult environmental challenge. Once formed, these network structures do not melt, flow, or dissolve to enable the use of conventional reprocessing or recycling methods.

The molding processes to produce footwear midsoles generate scraps. Scrap produced during processing of permanent networks is difficult to process and therefore cannot be fully reintroduced to the manufacturing process as a secondary feedstock. Only a small fraction of waste scrap from crosslinked polymers is ground and reintroduced as filler. Likewise, end-of-life parts produced from permanently crosslinked polymers have limited recycling options such as energy intensive grinding operations that generate only low value materials. As a result, a significant proportion of scrap and end-of-life parts accumulates as environmental waste.

In addition to a significant environmental impact, the fact that covalent, crosslinked EVA foams cannot be reprocessed by melting represents a significant cost for manufacturers. The high amount of waste limits the utilization rate of primary materials and generates cost to handle waste.

There is a need for technology that enables re-processing of crosslinked polymers, especially crosslinked foam EVA.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymeric composition that includes a thermoplastic polymer, the thermoplastic polymer including at least one monomer selected from a vinyl ester, a C2-C12 olefin, and combinations thereof, and a dynamic crosslinking group. The polymeric composition further includes a crosslinking agent to dynamically crosslink the thermoplastic polymer by ionic bonds or metal-ligand interaction.

In another aspect, embodiments disclosed herein relate to a polymeric composition that includes a thermoplastic polymer, the thermoplastic polymer including at least one monomer selected from a vinyl ester, a C2-C12 olefin, and combinations thereof, and a dynamic crosslinking group; a crosslinking agent to crosslink the thermoplastic polymer by ionic bonds or metal-ligand interaction; and wherein the crosslinking is relatively insensitive to the presence of molecular oxygen.

In another aspect, embodiments disclosed herein relate to a method for producing a polymeric composition, the method comprising processing a crosslinking system with a thermoplastic polymer to form a polymeric composition that includes the thermoplastic polymer including at least one monomer selected from a vinyl ester, a C2-C12 olefin, and combinations thereof, and a dynamic crosslinking group, where the polymeric composition further includes a crosslinking agent to dynamically crosslink the thermoplastic polymer by ionic bonds or metal-ligand interaction. The processing is at a first temperature which is less than a second temperature sufficient to form crosslinks in the polymeric composition.

In another aspect, embodiments disclosed herein relate to a method for producing a polymeric composition, the method comprising processing a crosslinking system with a thermoplastic polymer to form a polymeric composition that includes a thermoplastic polymer, the thermoplastic polymer including at least one monomer selected from a vinyl ester, a C2-C12 olefin, and combinations thereof; a crosslinking agent to crosslink the thermoplastic polymer by ionic bonds or metal-ligand interaction; and wherein the cros slinking is relatively insensitive to the presence of molecular oxygen. The processing is at a first temperature which is less than a second temperature sufficient to form crosslinks in the polymeric composition.

In another aspect, embodiments disclosed herein relate to a method of producing a polymeric composition which includes processing a polymeric composition above its melting or softening temperature and crosslinking the polymeric composition in the presence of molecular oxygen. The polymeric composition includes a thermoplastic polymer, the thermoplastic polymer including at least one monomer selected from a vinyl ester, a C2-C12 olefin, and combinations thereof, and a dynamic crosslinking group. The polymeric composition further includes a crosslinking agent to dynamically crosslink the thermoplastic polymer by ionic bonds or metal-ligand interaction.

In another aspect, embodiments disclosed herein relate to a method of producing a polymeric composition which includes processing a polymeric composition above its melting or softening temperature and crosslinking the polymeric composition in the presence of molecular oxygen. The polymeric composition that includes a thermoplastic polymer, the thermoplastic polymer including at least one monomer selected from a vinyl ester, a C2-C12 olefin, and combinations thereof; a crosslinking agent to crosslink the thermoplastic polymer by ionic bonds or metal-ligand interaction; and wherein the cros slinking is relatively insensitive to the presence of molecular oxygen.

In yet another aspect, embodiments disclosed herein relate to a method of reprocessing a polymer composition that includes reprocessing a polymer composition above a melting or softening temperature of the thermoplastic polymer, wherein after the reprocessing, the polymer composition maintains at least 40% of its initial storage modulus plateau above its melting temperature, as measured by dynamic mechanical analysis , as compared to the polymer composition before the reprocessing. The polymer composition includes a thermoplastic polymer comprising at least one monomer selected from a vinyl ester, a C2-C12 olefin, and combinations thereof and a dynamic crosslinking group; and a crosslinking agent that has dynamically crosslinked the thermoplastic polymer by ionic bonds or metal-ligand interaction.

In yet another aspect, embodiments disclosed herein relate to a method of reprocessing a polymer composition that includes reprocessing a polymer composition above a melting or softening temperature of the thermoplastic polymer, wherein after repeating the processing at least 2 additional times, the polymer composition maintains at least 40% of its initial storage modulus plateau above its melting temperature, as measured by dynamic mechanical analysis, as compared to the polymer composition before the reprocessing. The polymer composition includes polymeric composition that includes a thermoplastic polymer comprising at least one monomer selected from a vinyl ester, a C2-C12 olefin, and combinations thereof, and a crosslinking agent that has crosslinked the thermoplastic polymer by ionic bonds or metal-ligand interaction, wherein the cros slinking is relatively insensitive to the presence of molecular oxygen.

In yet another aspect, embodiments disclosed herein relate to an article comprising a polymeric composition that includes a thermoplastic polymer comprising at least one monomer selected from a vinyl ester, a C2-C12 olefin, and combinations thereof and a dynamic crosslinking group; and a crosslinking agent that dynamically crosslink the thermoplastic polymer by ionic bonds or metal-ligand interaction.

In yet another aspect, embodiments disclosed herein relate to an article comprising a polymeric composition that includes a thermoplastic polymer comprising at least one monomer selected from a vinyl ester, a C2-C12 olefin, and combinations thereof, and a crosslinking agent that crosslinks the thermoplastic polymer by ionic bonds or metal-ligand interaction, wherein the crosslinking is relatively insensitive to the presence of molecular oxygen.

Other aspects and advantages of the claimed subject matter will be apparent from the following description and the appended claims.

### BRIEF DESCRIPTION OF DRAWINGS

FIG. 1 shows a comparison of the DSC cooling curves for a thermoplastic polymer control, EVA, and EVA crosslinked with 1.5 and 3% Zn acrylate.

FIG. 2 shows a comparison of DSC heating curves (2^{nd} melt) for a thermoplastic polymer control, EVA, and EVA crosslinked with 1.5 and 3% Zn acrylate.

FIG. 3 shows shear rheology testing results.

FIG. 4 shows DMA storage modulus vs Temperature.

FIG. 5 shows DMA loss modulus vs Temperature.

### DETAILED DESCRIPTION

Embodiments disclosed herein relate to polymeric compositions, methods of forming and reprocessing such polymeric compositions, and articles formed from such polymeric compositions. The polymeric compositions may be thermoplastic polymers comprising at least one monomer selected from the group consisting of vinyl esters, C2-C12 olefins, and combinations thereof that are dynamically crosslinked. In accordance with embodiments of the present disclosure, the dynamic crosslinking reaction is relatively insensitive to the presence of molecular oxygen. As used herein the term “relatively insensitive” means a polymeric composition having a tackiness number above 5.

Dynamically crosslinked systems are a class of chemically crosslinked polymers, in which an external-stimulus (temperature, stress, pH, etc.) triggers bond-exchange reactions, thereby permitting the change of the network topology while keeping the number of bonds and crosslinks constant. The dynamic ionic or metal ligand bonds present can undergo associative exchange reactions, such that the network topology is able to change, the material relaxes stresses and flows. Dynamically crosslinked systems exhibit the characteristics of crosslinked materials at ambient temperatures (high chemical resistance, exceptional mechanical properties), while they can be processed or reprocessed as thermoplastic materials at elevated temperature.

In accordance with one or more embodiments, a polymeric composition may be prepared by mixing the thermoplastic polymer and a crosslinking system. The crosslinking system may comprise a crosslinking agent and a catalyst. The thermoplastic polymer may comprise a dynamic crosslinking group and/or a dynamic crosslinking group may be grafted thereto. Crosslinkable polymeric compositions may be prepared via a method comprising processing a crosslinking system with a thermoplastic polymer. Crosslinking of the polymeric composition may include processing that is conducted above the melting or softening temperature of the composition to trigger crosslinking of the polymeric composition. Moreover, because the crosslinked polymeric compositions are dynamically crosslinked, the previously crosslinked polymeric composition may be reprocessed in subsequent steps at elevated temperatures.

Thermoplastic Polymer

In one or more embodiments, the thermoplastic polymer includes at least one monomer selected from C2-C12 olefins, a vinyl ester, and combinations thereof. The olefins may comprise one or more of ethylene, 1-propene, 1-butene, 1-pentene, 1-hexene, 1-heptene, 1-octene, 1-nonene, 1-decene, 1-undecene, 1-dodecene and combinations thereof. Thus, for example, it is envisioned that the thermoplastic polymer may include polymers such as polyolefins, including ethylene homopolymers, copolymer of ethylene and one or more C3-C12 alpha olefins, propylene homopolymer, copolymers of propylene and one or more comonomers selected from ethylene, C4-C12 alpha-olefins and combinations thereof, ethylene vinyl acetate, poly(vinyl acetate), and combinations thereof. In copolymers of an olefin and vinyl ester(s), it is envisioned that the vinyl ester(s) may be present as comonomers in an amount ranging from a lower limit of 1, 5, 10, 15, 18, or 20 wt %, to an upper limit of any of 25, 40, 60, or 80 wt % of the total mass of the copolymer.In one or more particular embodiments, vinyl acetate may be used as monomer or comonomer. In one or more even more particular embodiments, the thermoplastic polymer may be a biobased polymer, especially ethylene vinyl acetate and polyethylene, whereas, for example, ethylene might be derived from biobased ethanol.

It is also envisioned that the thermoplastic polymer may include a branched vinyl ester comonomer (in combination with ethylene alone to form a copolymer or in combination with ethylene and vinyl acetate to form a terpolymer. Such copolymer and terpolymers are described in U.S. patent application Ser. No. 17/063,488, which is herein incorporated by reference in its entirety. For example, such branched vinyl ester monomers may include monomers having general structure (I):

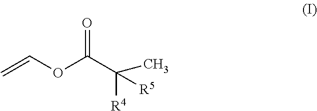

wherein R⁴ and R⁵ have a combined carbon number of 6 or 7. However, it is also envisioned that the other branched vinyl esters described in U.S. patent application Ser. No. 17/063,488 may be used.

In one or more embodiments, the thermoplastic polymer forms at least at least 1 wt %, at least 5 wt %, 10 wt %, 15 wt %, at least 20 wt %, at least 25 wt %, at least 50 wt %, at least 70 wt %, or at least 80 wt %, or at least 90 wt %, or at least 99 wt % of the polymeric composition. The amount of thermoplastic polymer may depend, for example, on the presence of other components such as but not limited to crosslinking agents, fillers, additives, oils, and/or plasticizers.

In referring to a thermoplastic polymer that forms the polymer composition described herein, it is intended that the polymer is dynamically crosslinked via a dynamic crosslinking group and addition of a crosslinking system. The dynamic crosslinking group may be incorporated into the thermoplastic polymer during polymerization, for example the vinyl esters of EVA, or the dynamic crosslinking group may be added to a base polymer after the base polymer has been polymerized. The dynamic crosslinking group may be added to a base polymer via for example a grafting reaction during a reactive processing step to form the thermoplastic polymer. The grafting reaction may comprise forming at least one covalent bond between a base polymer and a molecule containing a dynamic crosslinking group. Grafting may include, for example, melt grafting, solution grafting, or solid state grafting.

Dynamic Crosslinking Group

In one or more embodiments, the dynamic crosslinking group may be derived from an ester, a carboxylic acid, such as acrylic acid, or derivates thereof such as carboxylates, and combinations thereof.

As also mentioned above, the moiety or dynamic cros slinking group may be present in the thermoplastic polymer from polymerization (such as in the case of an ester in thermoplastics containing vinyl ester monomers) or such moiety may be reacted with a base polymer via a post-polymerization reactive processing to form the thermoplastic polymer. Such reacting processing may include, for example, melt grafting, solution grafting, or solid state grafting. It is also envisioned that the dynamic crosslinking group may be the same or different chemical species as a monomer forming the thermoplastic polymer. For example, in the case of the thermoplastic polymer being polyvinyl acetate, the vinyl acetate is both a monomer and a dynamic crosslinking group.

In one or more embodiments, the dynamic crosslinking group may include vinyl esters such as vinyl acetate, vinyl propionate, vinyl 2-ethylhexanoate, vinyl decanoate, vinyl neodecanoate, vinyl neononanoate, vinyl laurate, vinyl benzoate, vinyl pivalate, vinyl butyrate, vinyl trifluoroacetate, vinyl cinnamate, vinyl 4-tert-butylbenzoate, vinyl stearate, allyl cinnamate, vinyl methacrylate, and the like, and combinations thereof.

In one or more embodiments, the dynamic crosslinking group may include unsaturated organic acids, such as itaconic acid, maleic acid, acrylic acid, crotonic acid, methacrylic acid, fumaric acid, 1-Vinyl-1H-pyrrole-2-carboxylic acid, 1,2-Benzenedicarboxylic acid, and the like, and combinations thereof.

In one or more embodiments, the dynamic crosslinking group may comprise a moiety able to react with the dynamic crosslinking system. In one or more embodiments, the dynamic crosslinking group is present in the thermoplastic polymer in amounts up to 100 wt %, 90 wt %, 70 wt %, 50 wt %, 30 wt %, 10 wt %, 5 wt %, 4 wt %, 3 wt %, 2 wt %, 1 wt %, 0.05 wt %, or 0.01 wt % of the thermoplastic polymer.

Crosslinking Agent

In one or more embodiments, the crosslinking agent may form ionic bonds or metal-ligand bonds. The crosslinking agent may be selected from o-nucleophiles, n-nucleophiles, metal oxides, metal hydroxides, acid/alkaline catalysts such as NaOH or KOH , organic metal salts selected from the group consisting of acetylacetonates, diacrylates, carbonates, acetates and combinations thereof and wherein the metal is selected from the group consisting of Zinc, Molybdenum, Copper, Magnesium, Sodium, Potassium, Calcium, Nickel, Tin, Lithium, Titanium, Zirconium, Aluminum, Lead, Iron, Vanadium, and combinations thereof.

In one or more embodiments, the crosslinking agent forms a lower limit of any of 0.01 wt %, 0.1 wt %, 0.5 wt , at least 1 wt %, at least 2 wt %, or 3 wt %, of the polymeric composition, and an upper limit of any of 4 wt %, 5 wt %, 6 wt %, 8 wt %, 10 wt %, 12 wt %, 15 wt %, 20 wt % or 25 wt % where any lower limit can be used in combination with any upper limit.

Optional Additives

The polymer composition of the present disclosure may also include, in addition to crosslinked polymer, catalyst, and optional non-crosslinked polymer, one or more optional additives such as, but not limited to fillers, blowing agents, blowing accelerants, elastomer, plasticizer, processing aid, mold release, lubricant, dye, pigment, antioxidants, light stabilizers, flame retardant, antistatic agents, antiblock additives, or other additives to modify the balance of stiffness and elasticity in the polymer composition, such as fibers, fillers, scraps, nanoparticles, nanofibers, nanowhiskers, nanosheets, and other reinforcement elements. In some embodiments, one or more of such additives may be added during the initial mixing or melt processing of the crosslinked polymer and catalyst, while in one or more embodiments, one or more of such additives may be compounded in a subsequent process step.

Polymer compositions in accordance with the present disclosure may include one or more blowing accelerators (also known as kickers) that enhance or initiate the action of a blowing agent by lower the associated activation temperature. For example, blowing accelerators may be used if the selected blowing agent reacts or decomposes at temperatures higher than 170° C., such as 220° C. or more, where the surrounding polymer would be degraded if heated to the activation temperature. Blowing accelerators may include any suitable blowing accelerator capable of activating the selected blowing agent. In one or more embodiments, suitable blowing accelerators may include cadmium salts, cadmium-zinc salts, lead salts, lead-zinc salts, barium salts, barium-zinc (Ba—Zn) salts, zinc oxide, titanium dioxide, triethanolamine, diphenylamine, sulfonated aromatic acids and their salts, and the like. Polymer compositions in accordance with particular embodiments of the present disclosure may include zinc oxide as one of the one or more blowing accelerators.

Polymer compositions in accordance with the present disclosure may include one or more blowing agents to produce expanded polymer compositions and foams. Blowing agents may include solid, liquid, or gaseous blowing agents. In embodiments utilizing solid blowing agents, blowing agents may be combined with a polymer composition as a powder or granulate.

Blowing agents in accordance with the present disclosure may include chemical blowing agents that decompose at polymer processing temperatures, releasing the blowing gases such as N₂, CO, CO₂, and the like. Examples of chemical blowing agents may include organic blowing agents, including hydrazines such as toluenesulfonyl hydrazine, hydrazides such as oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical blowing agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

Polymer compositions in accordance with the present disclosure may contain one or more plasticizers to adjust the physical properties and processability of the composition. In some embodiments, plasticizers in accordance with the present disclosure may include one or more of bis(2-ethylhexyl) phthalate (DEHP), di-isononyl phthalate (DINP), bis (n-butyl) phthalate (DNBP), butyl benzyl phthalate (BZP), di-isodecyl phthalate (DIDP), di-n-octyl phthalate (DOP or DNOP), di-o-octyl phthalate (DIOP), diethyl phthalate (DEP), di-isobutyl phthalate (DIBP), di-n-hexyl phthalate, tri-methyl trimellitate (TMTM), tri-(2-ethylhexyl) trimellitate (TEHTM-MG), tri-(n-octyl, n-decyl) trimellitate, tri-(heptyl, nonyl) trimellitate, n-octyl trimellitate, bis (2-ethylhexyl) adipate (DEHA), dimethyl adipate (DMD), mono-methyl adipate (MMAD), dioctyl adipate (DOA)), dibutyl sebacate (DBS), polyesters of adipic acid such as VIERNOL, dibutyl maleate (DBM), di-isobutyl maleate (DIBM), benzoates, epoxidized soybean oils and derivatives, n-ethyl toluene sulfonamide, n-(2-hydroxypropyl) benzene sulfonamide, n-(n-butyl) benzene sulfonamide, tricresyl phosphate (TCP), tributyl phosphate (TBP), glycols/polyesters, triethylene glycol dihexanoate, 3gh), tetraethylene glycol di-heptanoate, polybutene, acetylated monoglycerides; alkyl citrates, triethyl citrate (TEC), acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trihexyl o-butyryl citrate, trimethyl citrate, alkyl sulfonic acid phenyl ester, 2-cyclohexane dicarboxylic acid di-isononyl ester, nitroglycerin, butanetriol trinitrate, dinitrotoluene, trimethylolethane trinitrate , diethylene glycol dinitrate, triethylene glycol dinitrate, bis (2,2-dinitropropyl) formal, bis (2,2-dinitropropyl) acetal, 2,2,2-trinitroethyl 2-nitroxyethyl ether, mineral oils, vegetable or biobased oil, among other plasticizers and polymeric plasticizers. In particular embodiments, one of the one or more plasticizers may be mineral oil.

Polymer compositions in accordance with the present disclosure may include one or more inorganic and nanofillers such as talc, glass fibers, marble dust, cement dust, clay, carbon black, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium based oxides, calcium carbonate, graphene, carbon nanotube and other carbon based nanostructures, boron nitride nanotubes, cellulose based nanostructures, and other nanoparticles, nanofibers, nanowhiskers, nanosheets, polyhedral oligomeric silsesquioxane (POSS), recycled EVA, and other recycled rubbers. As defined herein, recycled EVA may be derived from regrind materials that have undergone at least one processing method such as molding or extrusion and the subsequent sprue, runners, flash, rejected parts, and the like, are ground or chopped. While in accordance with embodiments of the present disclosure such recycled materials are combined with a catalyst to form the polymer composition described herein which has dynamic crosslinked networks, it is also envisioned that additional recycled EVA or other polymer may be added as filler in a subsequent compounding step.

Crosslinked Polymer Compositions

In one or more embodiments, upon crosslinking, the composition exhibits a plateau elastic storage modulus within a temperature range of 20 to 150° C.

In one or more embodiments, upon crosslinking, the composition has an elastic storage modulus that is time-dependent at temperatures above 120° C., such that it decreases by at least 50% relative to its initial value (G₀, plateau modulus) within 10,000 seconds at a temperature less than 230° C. The value for normalized relaxation modulus may be obtained via exponential decay fittings to the elastic storage modulus data. The plateau modulus corresponds to the fit at t=0 s, which is also referred to as G₀.

Processing

In one or more embodiments, a crosslinkable polymeric composition which may comprise the thermoplastic polymer and the crosslinking system comprising the crosslinking agent and the catalyst are subjected to a melt-processing operation to form the crosslinkable polymer composition (i.e., not yet dynamically crosslinked). The polymeric composition may then be dynamically crosslinked as part of a multi-step process. In the first step, a polymeric composition is prepared by melt mixing a thermoplastic polymer and crosslinking agent at a temperature which is not sufficient to form dynamic crosslinks in the polymeric composition. In a second step, the polymeric composition formed in the first step is crosslinked, optionally in the presence of molecular oxygen, in a process using for example a hot air tunnel, oven, autoclave, or other suitable cros slinking apparatus. The step of crosslinking the polymeric composition is performed at an elevated temperature sufficient to form the dynamically crosslinked polymeric composition. The crosslinking step may be performed in the same apparatus used to form the polymeric composition, or may be performed in a separated apparatus. The dynamic crosslinking is advantageously performed without the use of peroxides. As such, the chemistries for crosslinking are relatively insensitive to molecular oxygen. The crosslinking reaction to form dynamic crosslinks may be performed in environments comprising oxygen.

In one or more embodiments, a crosslinkable polymeric composition which may comprise the thermoplastic polymer and the crosslinking agent may be subjected to a melt-processing operation to form a polymer composition which is dynamically crosslinked, in a one-step or multi-step process. Specifically, the thermoplastic polymer and crosslinking agent may be mixed at an elevated temperature, i.e. above the softening or melting temperature of the composition. For example, a mixture of thermoplastic polymer and crosslinking agent may be subjected to a processing temperature greater than a processing temperature of the non-crosslinked thermoplastic polymer to form the polymer composition. That is, the mixture may be subjected to temperatures higher than either the melting or softening point of the non-crosslinked polymers. The temperature shall be selected according to requirements for the selected processing operation, as long as it does not exceed the polymers' degradation temperature. The softening point of an amorphous non-crosslinked polymer is determined by a Vicat method according to ASTM D-1525, and the melting point of a semi-crystalline non-crosslinked polymer is measured according to DSC.

In one or more embodiments, polymeric compositions in accordance with the present disclosure may be prepared using continuous or discontinuous extrusion or in a continuous or batch mixing. Methods may use single-, twin- or multi-screw extruders, internal mixer, a hot-air tunnel, an oven, a hydraulic press, an injection molding machine, an additive manufacturing machine, or an autoclave, any of which may be used at temperatures ranging from 60° C. to 270° C. in some embodiments, and from 140° C. to 230° C. in some embodiments. In some embodiments, raw materials (thermoplastic polymer, and crosslinking system are added to an extruder or other processing method, simultaneously or sequentially.

Methods of preparing polymer compositions in accordance with the present disclosure may include the general steps of combining a thermoplastic polymer, and a crosslinking agent in an extruder or mixer; melt extruding the composition; and forming pellets, filaments, powder, bulk compound, or sheets of the polymer composition.

Polymer compositions prepared by the present methods may be in the form of granules that are applicable to different molding processes, including processes selected from extrusion, calendaring, injection molding, foaming, compression molding, steam chest molding, super critical molding, additive manufacturing, and the like, to produce manufactured articles.

Given the dynamic crosslinking, embodiments of the present disclosure also relate to reprocessing of a crosslinked polymer composition. In one or more embodiments, because of intrinsic properties of the used chemistries, the crosslinked polymer formulation may be reprocessed or recycled using similar processing applied to the virgin polymer in the initial crosslinking process. Scrap or end-of-life parts may undergo regrinding or other required process to feed the material in the desired operation, with acceptable decrease in processibility or properties, in a way that it is still useful as secondary feedstock. The intent is that, in general, the reprocessing parameters are similar to what is used for the initial manufacturing process. Advantageously, the polymer compositions may be reprocessed and the properties of the polymer composition may be substantially maintained as compared to immediately prior to the reprocessing. Specifically, in one or more embodiments, after the reprocessing, the polymer composition maintains at least 40% of its initial storage modulus plateau above its melting temperature, as measured by dynamic mechanical analysis, as compared to the polymer composition before the reprocessing.

It is also envisioned that the reprocessing occurs repeatedly (through multiple cycles). In one or more embodiments, after the repeated reprocessing, such as after 3 or even after 5 cycles of reprocessing, the polymer composition maintains at least 40% of its initial storage modulus plateau above its melting temperature, as measured by dynamic mechanical analysis, as compared to the polymer composition before the reprocessing

Articles

In one or more embodiments, an article may be formed from the dynamically crosslinked polymeric composition. The articles formed may be either foamed or non-foamed.

In one or more embodiments, the article is selected from the group consisting of a shoe sole, insole, midsole, unisole or other shoe accessories; a gasket, a hose, a cable, a wire, a sealing system, a conveyor belt, foxing tape, an NVH material, acoustic insulation, roofing material, and industrial flooring. In embodiments of a multilayer article, it is envisioned that at least one of the layers comprises the polymer composition of the present disclosure.

Oxygen Insensitivity During Crosslinking

The following procedure was used to evaluate the tackiness of crosslinked polymeric composition after curing (crosslinking) in an oven (not vacuum or inert atmosphere).

A sheet of the polymeric composition is prepared via calandering and/or compression molding, followed by cutting with razorblade, scissor, or other cutting device, with dimensions of 0.7-3 mm thickness, 2.5 cm width and 4 cm length (although dimensions are not the critical parameters, since it is mostly a surface phenomenon). After that, it is put in an oven for cure either being placed over some surface, such as a metallic tray, or, hung using a metal wire to the top of the oven, which was pre-heated hot air oven set to 205° C. for 15 minutes.

After 15 minutes of cure, the sheet is removed and placed immediately on an isolating surface (e.g., cured rubber), followed by the immediate coverage with a Kleenex® Facial Tissue, firm pressure by hand to the entire rubber surface, and placing a 1.8 kg weight with a flat surface over the specimen for five minutes. After cooling to room temperature, the tissue paper is carefully removed.

Upon visual evaluation, the polymeric surface should not present tissue paper fibers. If a great portion of tissue paper or its fibers adhere to the polymer, this is indicative of a poor surface crosslinking, or that a formulation has excessive surface tackiness.

The metric for this test is defined as the Tackiness Number, being the percentage of polymeric surface covered with no paper fibers÷10, ranging from 10 to 0. A tack-free surface (no paper fibers) has a rating of 10, meanwhile a poor material surface that is completely covered in tissue paper fibers has a grade of 0.

In accordance with embodiments of the present disclosure, crosslinked polymeric compositions that are relatively insensitive to the presence of molecular oxygen have a tackiness number above 5. In more specific embodiments, crosslinked polymer compositions may have a tackiness number of at least 6, 7, 8, or 9.

### EXAMPLES

### Example 1

### Melt/Mixing of EVA with Dynamic Crosslinking Agents

Elastomeric networks were produced by extruding an ethylene-vinyl acetate copolymer (EVA) with zinc carboxylic acid salts at temperatures greater than then melting temperature of the EVA. Conventional EVA (Braskem commercial grade HM728, VAc content 28 wt %, Melt Index (190° C./2.16 kg=6 g/10 min) was melt/mixed with a zinc-centered dicarboxylic acid salt in a Werner-Pfleiderer 18 mm twin screw extruder. In a series of Comparative Examples, EVA was extruded with dicumyl peroxide (DCP) using the same extrusion conditions. Dicumyl peroxide is a conventional crosslinking agent that is widely used to crosslinked EVA in commercial practice.

The extrusion conditions are detailed in Table 1. For each formulation, EVA pellets were coated with a small amount (0.4 wt % of mineral oil) to facilitate mixing, then dry-blended with the DCP or zinc diacrylate. The mixture or EVA plus DCP or EVA plus zinc diacrylate was introduced to the hopper of the extruder, and the extrusion conditions were selected to avoid crosslinking the dicumyl peroxide. The formulations were extruded through a die, cooled in a water bath, and pelletized.

Two additional samples (Example 7 and Example 8) were produced by melt/mixing EVA HM728 with zinc acetyl acetenoate (Zn(acac)₂) in an Xplore MC15 microcompounder with all temperature zones set to 120° C. EVA pellets were fed to the mixing chamber using the feed hopper, and they were mixed using a screw speed of 150 rpm for about 1 minute, until the force became constant, indicating that they had fully melted. Then, zinc acetyl acetenoate was fed to the mixing chamber. Mixing with re-circulation was allowed to continue for 1 additional minute. The mixture was then extruded through the die and cooled in air.

TABLE 1

| | | extruder barrel temperature (° C.) | | | | | |
|---|---|---|---|---|---|---|---|
| | | ZONE 0 | | | | | |
| Example | formulation | (Feed Throat) | ZONE 1 | ZONE 2 | ZONE 3 | ZONE 4 | ZONE 5 |
| COMPARATIVE 1 | EVA control | 50 | 95 | 107 | 119 | 125 | 129 |
| COMPARATIVE 2 | 0.5 wt % DCP | 50 | 91 | 105 | 113 | 120 | 120 |
| COMPARATIVE 3 | 1 wt % DCP | 50 | 90 | 104 | 114 | 119 | 120 |
| COMPARATIVE 4 | 2 wt % DCP | 50 | 89 | 102 | 115 | 122 | 122 |
| EXAMPLE 5 | 1.5 wt % Zn Acr | 50 | 90 | 114 | 122 | 120 | 120 |
| EXAMPLE 6 | 3 wt % Zn Acr | 50 | 90 | 104 | 114 | 119 | 120 |
| EXAMPLE 7 | 1.2 wt % Zn(acac)₂ | 25 | 120 | 120 | 120 | 120 | 120 |
| EXAMPLE 8 | 2.4 wt % Zn(acac)₂ | 25 | 120 | 120 | 120 | 120 | 120 |

| | | | screw | | Die | MELT | feed |
|---|---|---|---|---|---|---|---|
| | extruder barrel temperature (° C.) | | speed, | % | Pressure | TEMP, | rate, |
| Example | ZONE 6 | ZONE 7 | rpm | TORQUE | (Bar) | C. | Kg/hr |
| COMPARATIVE 1 | 130 | 140 | 300 | 39 | 30 | 148 | 4.0 |
| COMPARATIVE 2 | 120 | 120 | 300 | 31 | 32 | 121 | 2.0 |
| COMPARATIVE 3 | 119 | 121 | 300 | 34 | 39 | 122 | 2.0 |
| COMPARATIVE 4 | 121 | 122 | 300 | 40 | 46 | 137 | 4.0 |
| EXAMPLE 5 | 120 | 120 | 300 | 26 | 35 | 123 | 2.0 |
| EXAMPLE 6 | 120 | 120 | 300 | 29 | 39 | 120 | 2.0 |
| EXAMPLE 7 | 120 | N/A | 150 | N/A | N/A | N/A | N/A |
| EXAMPLE 8 | 120 | N/A | 150 | N/A | N/A | N/A | N/A |

Differential Scanning Calorimetry

To illustrate the formation of dynamically-crosslinked networks, thermal responses of the extruded EVA blends were measured by differential scanning calorimetry (DSC,) a Q200 instrument manufactured by TA Instruments.

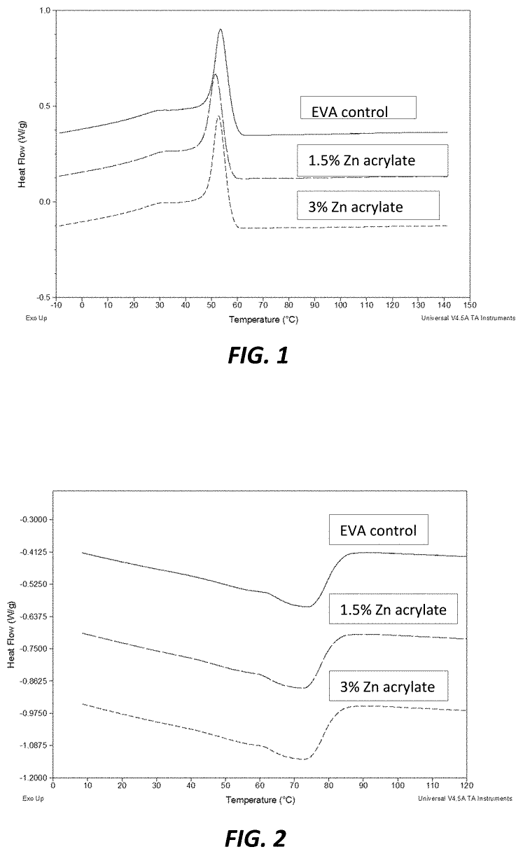

In a first heating step, samples were heated to 160° C. at a heating rate of 10 C/minute. Temperature was held constant at 160° C. Samples were then cooled to −20° C. at a rate of 10° C./minute and equilibrated at −20° C. for 1 minute. In a second heating step, samples were heated to 160° C. at a heating rate of 10° C./minutes, held at 160° C. for 1 minute, then cooled to 30° C. at a rate of 10° C./minute. Cooling curves obtained after the first heating step are reported in FIG. 1. Heating curves obtained after the second heating step are reported in FIG. 2.

The crystallization peak temperature, Tc, observed after the first heating step, and the melting temperature, Tm observed after the second heating step are reported in Table 2 for each formulation.

The comparative examples in Table 2 illustrate that conventional crosslinking of EVA with dicumyl peroxide (DCP) leads to decreases in both the melting temperature and the crystallization temperature. The magnitudes of these shifts to lower Tm and Tc values increase as the amount of DCP increases. For the inventive compositions, the value of crystallization temperature, Tc, decreases relative to un-crosslinked EVA. These shifts to lower Tc suggest that dynamically-crosslinked networks have formed as a result of extruding EVA with the zinc salts.

TABLE 2

| | Crosslinking | | |
|---|---|---|---|
| Example | agent | Tm, C. | Peak Tc, C. |
| COMPARATIVE 1 | none | 73.8 | 53.5 |
| COMPARATIVE 2 | 0.5 wt % DCP | 70.7 | 49.8 |
| COMPARATIVE 3 | 1 wt % DCP | 69.3 | 48.6 |
| COMPARATIVE 4 | 2 wt % DCP | 68.7 | 48.1 |
| EXAMPLE 5 | 1.5 wt % Zn acrylate | 72.9 | 51.8 |
| EXAMPLE 6 | 3 wt % Zn acrylate | 73.2 | 52.7 |

Shear Rheology

Small angle oscillatory shear (SAOS) measurements were using an Anton Parr torque rheometer operating from ambient to 150 C. Samples were prepared by molding the extruded EVA pellets in a Carver press to provide disks with 25 mm diameter. Viscoelastic response was measured by first equilibrating the samples at 25° C., then increasing temperature to 150° C. at a heating rate of 2° C./minute. A normal force of 10 N was applied.

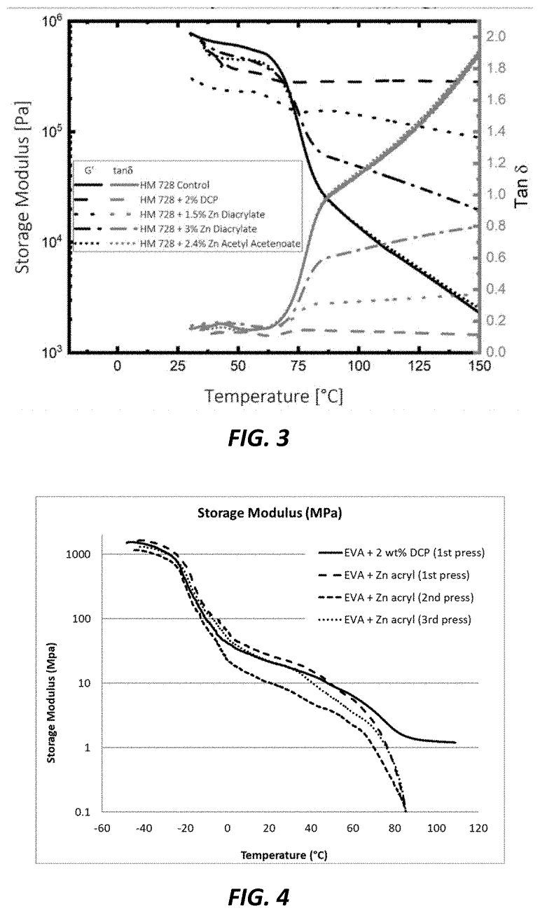

The results are reported in FIG. 3. The elastic storage modulus (G′) of the control sample exhibits a first plateau over the temperature range of 25°-60° C., then decreases sharply at 75° C. and continues to decrease as temperature increases. The sample that is crosslinked with dicumyl peroxide (DCP) exhibits a G′ plateau in the 25°-60° C. range that is significantly lower than that of the control. This is consistent with the formation of an elastic network, which inhibits the polyethylene component of the EVA from crystallizing. This suppression of crystallization is also observed by DSC. At temperatures greater than 75° C., the DCP-cured sample exhibits a broad G′ plateau, indicating the formation of a rubbery network. Over the temperature range from about 75° C. to 150° C., the DCP-cured sample has tan delta values less than 1, which is another indication that a crosslinked, elastomeric network has formed.

Like the DCP-cured sample, the inventive compositions that include Zn Diacrylate also exhibit lower plateau modulus values over the 25°-60° C. temperature range than the control, suggesting that crystallization has been suppressed. These samples also exhibit tan delta values less than 1 at temperatures greater than 75° C. The lower plateau modulus and the tan delta less than 1 both indicate the formation of a crosslinked network in the inventive compositions.

### Example 2

### Re-Processing (Multiple Melting and Cooling Cycles)

To illustrate that the inventive compositions can be re-processed by heating and melting, extruded pellets were pressed multiple times in a Carver press using the conditions listed in Table 3. Pellet samples were pressed between steel plates, using a 0.6 mm-thick brass mold to control sample thickness. After a first pressing step, the film was cooled, cut into small pieces, and pressed again to form a second film. The second film was cut into small pieces, and pressed to form a third film. After each press, a sample of film was collected for dynamic mechanical analysis.

Two formulations were tested for re-processing performance: Comparative Example 4, which contained 2 wt % DCP, and Inventive Example 6, which contained 3 wt % zinc diacrylate. The Comparative sample containing dicumyl peroxide was pressed only one time (1^{st} press,) because it did not flow upon heating in subsequent pressing steps. The Inventive sample provided a smooth, uniform film after each pressing, demonstrating that the composition flowed to take the shape of the mold.

TABLE 3
(Film pressing conditions)

| | | |
|---|---|---|
| 1st press | 5 min @ 110 C. | 15 min @ 160 C., 20 bar |
| 2^{nd} & 3^{rd} press | 5 min @110 C. | |

Viscoelastic responses of the pressed films were measured by dynamic mechanical analysis (DMA) temperature sweep using a rheometer manufactured by TA Instruments outfitted with a tension fixture. Sample dimensions were 0.6 mm thick, 7 mm wide, and 22-26 mm long. Strain amplitude was 15 microns, frequency was 1 Hz, and heating rate was 3 degrees C. per minute.

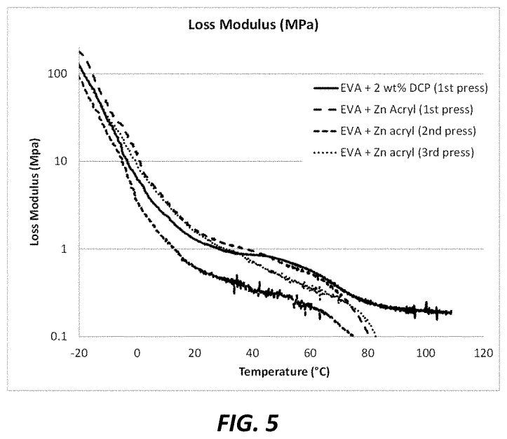

Elastic modulus and storage modulus values are reported as a function of temperature in FIGS. 4 and 5. Like the peroxide-cured formulation, the inventive composition exhibits a plateau storage modulus over temperatures ranging from about 20° C. to about 80° C. After three processing steps, the plateau modulus of the inventive composition retains at least half of its initial value, which is taken to be the value of E′ after the first pressing.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polymeric composition comprising:
a thermoplastic polymer comprising:
at least one monomer selected from the group consisting of vinyl esters, C₂-C₁₂ olefins, and combinations thereof; and
a dynamic crosslinking group; and
a crosslinking agent to dynamically crosslink the thermoplastic polymer by ionic bonds or metal-ligand interaction.

2. The polymeric composition of claim 1, wherein the dynamic crosslinking group is selected from the group consisting of esters, carboxylic acids, derivatives of carboxylic acids and combinations thereof.

3. The polymeric composition of claim 1, wherein the at least one monomer contains the dynamic crosslinking group.

4. A polymeric composition comprising:
a thermoplastic polymer comprising:
at least one monomer selected from the group consisting of vinyl esters, C₂-C₁₂ olefins, and combinations thereof; and
a crosslinking agent to crosslink the thermoplastic polymer by ionic bonds or metal-ligand interaction;
wherein the cros slinking is relatively insensitive to the presence of molecular oxygen.

5. The polymeric composition of claim 4, wherein the thermoplastic polymer comprises at least one moiety selected from the group consisting of esters, carboxylic acids, derivatives of carboxylic acids and combinations thereof.

6. The polymeric composition of claim 4, wherein the crosslinking agent is selected from the group consisting of o-nucleophiles, n-nucleophiles, metal oxides, metal hydroxides such as NaOH of KOH, organic metal salts selected from the group consisting of acetylacetonates, diacrylates, carbonates, acetates and combinations thereof and wherein the metal is selected from the group consisting of Zinc, Molybdenum, Copper, Magnesium, Sodium, Potassium, Calcium, Nickel, Tin, Lithium, Titanium, Zirconium, Aluminum, Lead, Iron and Vanadium, and combinations thereof.

7. The polymeric composition of claim 1, wherein the thermoplastic polymer is dynamically crosslinked by the crosslinking system.

8. The polymeric composition of claim 7, wherein the dynamic crosslinks are formed via ionic or metal-ligand bonds.

9. The polymeric composition of claim 7, wherein the composition exhibits a plateau elastic storage modulus within a temperature range of 20 to 150° C.

10. The polymeric composition of claim 7, wherein the elastic storage modulus is time-dependent at temperatures above 120° C., such that it decreases by at least 50% relative to its initial value (G₀, plateau modulus) within 10,000 seconds at a temperature less than 230° C.

11. A method for producing a polymeric composition comprising:
processing a crosslinking system with a thermoplastic polymer to form the polymeric composition of claim 1,
wherein the processing is at a first temperature, which is less than a second temperature sufficient to form crosslinks in the polymeric composition.

12. The method of claim 11, wherein the processing comprises melt mixing.

13. The method of claim 11, further comprising: prior to the processing, reacting via a post-polymerization reactive processing a base polymer with at least one moiety selected from the group consisting of esters, carboxylic acids, derivatives of carboxylic acids and combinations thereof to form the thermoplastic polymer.

14. The method of claim 13, wherein the reactive processing comprises melt grafting, solution grafting, or solid state grafting.

15. The method of claim 12, further comprising:
processing the polymeric composition at the second temperature which is above the melting or softening temperature, thereby crosslinking the polymeric composition.

16. The method of claim 15, wherein the crosslinking takes place in the presence of molecular oxygen.

17. The method of claim 15, wherein the thermoplastic polymer is first formed by the reactive processing, then melt mixed with the crosslinking system and then crosslinked.

18. A method of producing a polymeric composition, comprising:
processing the polymeric composition of claim 1 above its melting or softening temperature in an internal mixer or extruder; and
crosslinking the polymeric composition in the presence of oxygen.

19. The method of claim 18, wherein the cros slinking is in an internal mixer, an extruder, a hot air tunnel, an oven, a hydraulic press, an injection molding machine, an additive manufacturing machine, or an autoclave.

20. The method of claim 18, further comprising: reprocessing the crosslinked polymer composition.

21. A method of reprocessing a polymer composition, comprising:
reprocessing the polymer composition of claim 7 above a melting or softening temperature of the thermoplastic polymer, wherein after the reprocessing, the polymer composition maintains at least 40% of its initial storage modulus plateau above its melting temperature, as measured by dynamic mechanical analysis, as compared to the polymer composition before the reprocessing.

22. The method of claim 21, further comprising: repeating the processing at least 2 additional times, and wherein after the repeated reprocessing, the polymer composition maintains at least 40% of its initial storage modulus plateau above its melting temperature, as measured by dynamic mechanical analysis, as compared to the polymer composition before the reprocessing.

23. An article comprising the polymeric composition of claim 7.

24. The article of claim 23, wherein the article is non-foamed.

25. The article of claim 23, wherein the article is foamed.
